(19) United States
(12) Patent Application Publication
(10) Pub. No.: US 2019/0325250 A1
(43) Pub. Date: Oct. 24, 2019

(54) Reconfigurable 3D Pixel-Parallel Neuromorphic Architecture for Smart Image Sensor

(71) Applicant: BOARD OF TRUSTEES OF THE UNIVERSITY OF ARKANSAS, Fayetteville, AR (US)

(72) Inventors: Christophe Bobda, Fayetteville, AR (US); Pankaj Bhowmik, Fayetteville, AR (US); Md Jubaer Hossain Pantho, Fayetteville, AR (US); Marjan Asadinia, Fayetteville, AR (US)

(73) Assignee: BOARD OF TRUSTEES OF THE UNIVERSITY OF ARKANSAS, Fayetteville, AR (US)

(21) Appl. No.: 16/393,923

(22) Filed: Apr. 24, 2019

Related U.S. Application Data
(60) Provisional application No. 62/661,852, filed on Apr. 24, 2018.

(51) Int. Cl. G06K 9/46; G06K 9/00; H04N 5/232

(52) U.S. Cl. CPC G06K 9/4604; H04N 5/23229; G06K 9/00986

(57) ABSTRACT

A digital image capturing and processing system and method having a plurality of intertwined processing planes for the efficient processing of information associated with an image.

### RELATED APPLICATIONS

This application claims priority to U.S. Provisional Application Ser. No. 62/661,852 filed on Apr. 24, 2018, which is incorporated herein in its entirety.

### STATEMENT REGARDING FEDERALLY SPONSORED RESEARCH & DEVELOPMENT

This invention was made with government support by the National Science Foundation under CNS 1618606. The government has certain rights in the invention.

### INCORPORATION BY REFERENCE OF MATERIAL SUBMITTED ON A COMPACT DISC

Not applicable.

### BACKGROUND OF THE INVENTION

Cameras are pervasively used for surveillance and monitoring applications and can capture a substantial amount of image data. The processing of this data, however, is either performed post-priori or at powerful backend servers. While post-priori and non-real-time video analysis may be sufficient for certain groups of applications, it does not suffice for applications such as autonomous navigation in complex environments, or hyperspectral image analysis using cameras on drones, that require near real-time video and image analysis, sometimes under SWAP (Size Weight and Power) constraints. Future big data challenges in real-time imaging can be overcome by pushing computation into the image sensor. The resulting systems will exploit the massive parallel nature of sensor arrays to reduce the amount of data analyzed at the processing unit as well as the overall power consumption.

### BRIEF SUMMARY OF THE INVENTION

In one embodiment, the present invention provides a device for performing fast and efficient on-chip image analysis in a manner that mimics the image processing done by the human brain. The device uses a plurality of different logical planes which are structured hierarchically to perform computing with maximal parallelism. At least one initial plane is fine-grained and detects the first features of an image. At least one intermediate plane performs higher level image processing where shapes and motion are detected. At least one final plane then identifies the shapes and objects. The design uses pixel parallel architecture and XPUs which are reconfigurable.

In one embodiment, the present invention overcomes limitations found in existing architectures by providing a design using a highly parallel, hierarchical, reconfigurable and vertically-integrated 3D sensing-computing architecture for real-time, and low-power video analysis. To increase performance, while reducing power consumption, the proposed architecture of the present invention leverages the concept of the biological vision system to reduce redundancy and deploy more resources on an important part of scene images.

In other embodiments, to overcome the limitations of existing architectures, this invention uses a highly parallel, hierarchical, reconfigurable and vertically-integrated 3D sensing-computing architecture, along with high-level synthesis methods for real-time, low-power video analysis. The architecture is composed of hierarchical intertwined planes, each of which consists of computational units called XPUs. The lowest-level plane processes pixels in parallel to determine low-level shapes in an image while higher-level planes use outputs from low-level planes to infer global features in the image. The invention mimics the way brain process images, by focusing more on important visual parts to reduce data redundancy and power consumption. As in the brain, the recognition process is hierarchical top-down and bottom-up. It can be compared with feedback and feed-forward process. The brain-like-circuit provides faster parallel operation, eliminates redundancy, with low power consumption, and high level of reliability.

In other embodiments, the present invention provides a system and method for performing fast and efficient on-chip image analysis in a manner that mimics the image processing done by the human brain comprising: an architecture that is composed of hierarchical intertwined planes, each of which consists of one or XPUs; and the lowest-level plane processes pixels in parallel to determine low-level shapes in an image while higher-level planes use outputs from low-level planes to infer global features in the image.

In other embodiments, the present invention provides a system and method for performing fast and efficient on-chip image analysis in a manner that mimics the image processing done by the human brain comprising: an hierarchical image processing hardware architecture made of computational units that reside in a plurality of inter-twined logical planes which may be comprised of three planes. The first plane consists of fine-grained reconfigurable components that collaboratively analyze a collection of pixels to detect the early visual feature of the input image the results of which are fed into the next plane where relatively higher-level image processing for instance line, circle, triangle, motion detection, and feature extraction for recognition is performed and mapped on salient events in an image. The map is then searched for events and objects in the third plane of computation.

In other embodiments, the present invention provides a system and method wherein a higher sampling frequency is used in relevant regions, which are dynamically detected with relevant information, and produces a feedback path.

In other embodiments, the present invention provides a system and method wherein in order to detect saliency, the early visual features such as the number of edges or corner pixels in different regions of the image are extracted.

In other embodiments, the present invention provides a system and method of wherein the knowledge of features for a region are combined to calculate visual saliency.

In other embodiments, the present invention provides a system and method for performing fast and efficient on-chip image analysis in a manner that mimics the image processing done by the human brain comprising an architecture that is organized into three planes namely Pixel-Level Processing Plane (PLPP), Structure-Level Processing Plane (SLPP), and Knowledge Interface Plane (NIP); and the planes are comprised of reconfigurable processing units to meet the computational need of an application.

In other embodiments, the present invention provides a system and method wherein the design is a form of focal plane architecture that brings the computation closer to the image sensor and which is giving real-time application.

In other embodiments, the present invention provides a system and method wherein the design has pixel-parallel architecture, which improves system performance by increasing system speed.

In other embodiments, the present invention provides a system and method with sufficient speed for use in a high-speed imaging application.

In other embodiments, the present invention provides a system and method having computational units (XPUs) wherein the XPUs are reconfigurable to adopt different computer vision applications.

In other embodiments, the present invention provides a system and method wherein the application is subdivided into several parts and XPUs process those parts in parallel maintaining a hierarchy.

In other embodiments, the present invention provides a system and method wherein in the hierarchical processing, every layer of the hierarchy there is a gradual graduation of data volume which reduces redundancy.

In other embodiments, the present invention provides a system and method wherein the third layer is a sequential processor.

In other embodiments, the present invention provides a system and method wherein the design offers a small volume of data to the processor to achieve a speedup in the sequential operation.

In other embodiments, the present invention provides a system and method wherein the design has different clock speed, all XPUs in the first layer performs parallel with different clock speed and achieves a significant amount of power savings.

In other embodiments, the present invention provides a system and method wherein a number of XPUs in the second layer remain idle and reduces power consumption.

In other embodiments, the present invention provides a system and method wherein the reduction of data volume offers less time for operation in the third layer and thus the third layer has reduced power consumption.

In other embodiments, the present invention provides a system and method for use in camera systems having billions of pixels.

In other embodiments, the present invention provides a system and method for use in video surveillance, consumer electronics, drones and remote sensing, self-steering or operable machines and vehicles and health care.

Additional objects and advantages of the invention will be set forth in part in the description which follows, and in part will be obvious from the description, or may be learned by practice of the invention. The objects and advantages of the invention will be realized and attained using the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 is an overview of the 3D bottom-up architecture for an embodiment of the present invention wherein the computational units are organized in planes, where the output of each layer serves as an input for the next plane and each PPU is connected to its eight neighboring PPUs.

FIG. 2 illustrates a PPU-RPU interconnection structure with feedforward and feedback connections for another embodiment of the present invention wherein the SLPP layer sense feedback to the input pixel array to adjust sensing and processing frequency for an embodiment of the present invention.

FIG. 3 shows (a) shows a PPU array in a PLPP layer for an embodiment of the present invention; (b) illustrates the interconnection among the PPU for an embodiment of the present invention and (c) shows the components of a PPU for an embodiment of the present invention including a photodiode, ADC, interconnect manager and digital processor.

FIG. 4 illustrates the signal flow from the ADC to digital processors for an embodiment of the present invention.

FIG. 5 illustrates a clock musk (CM) unit for an embodiment of the present invention.

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention.

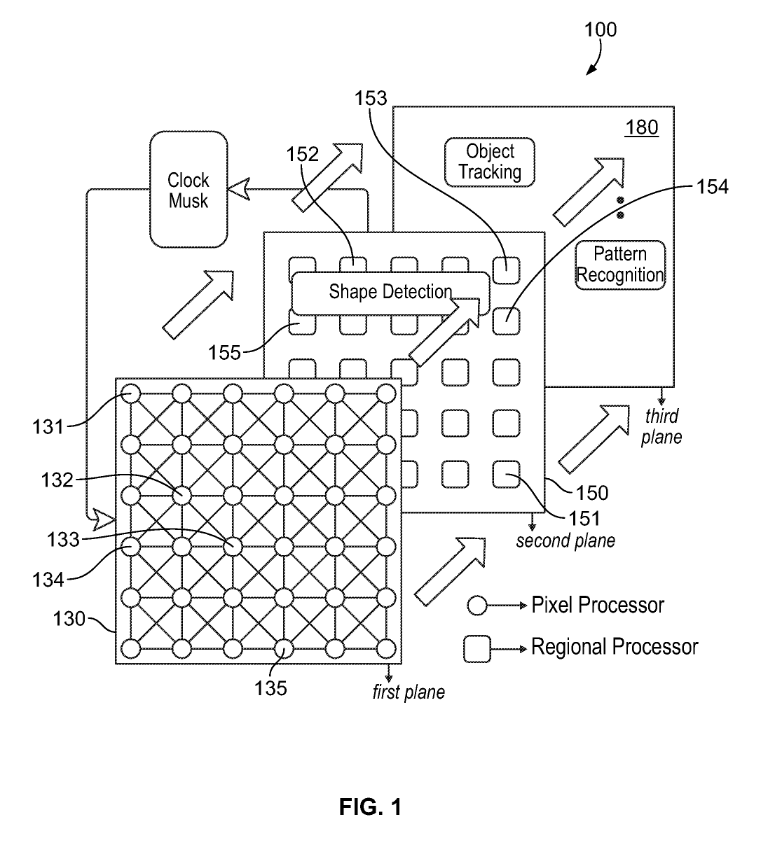

In one embodiment, the present invention provides, as shown in FIG. 1, an architecture 100 that exploits saliency-based visual attention found in the brain, along with maximal parallelism, which results in a hierarchical image processing hardware architecture made of computational processing units (XPUs) that reside in a plurality of inter-twined logical planes. FIG. 1 provides an exemplary architecture comprised of planes 130, 150, and 180. In other embodiments, at least one plane is provided at each level. Each plane may also have one or more XPUs that act in parallel and the final plane may process inputs sequentially.

Plane 130 may consist of fine-grained reconfigurable components that collaboratively analyze a collection of pixels to detect the early visual feature of the input image. In a preferred embodiment, plane 130 may consist of a plurality of pixel processors 131-135 that may work in parallel. The results of this step are fed into the next plane 150 where relatively higher-level image processing for instance line, circle, triangle, motion detection, feature extraction for recognition, etc. is performed and mapped on salient events in an image. In a preferred embodiment, plane 150 includes a plurality of regional processing units (RPUs) 151-155 that may work in parallel. The map is then searched for events and objects in the third plane of computation 180 which may process data sequentially.

The higher sampling frequency is used in relevant regions, which are dynamically detected with relevant information, and produces a feedback path. In order to detect saliency, the early visual features such as the number of edges or corner pixels in different regions of the image are extracted. The knowledge of features for a region is combined to calculate visual saliency.

In other aspects, as shown in FIG. 2, architecture 200 may be organized into a plurality of planes namely Pixel-Level Processing Plane (PLPP) 230, Structure-Level Processing Plane (SLPP) 250, and Knowledge Interface Plane (NIP) 280. The planes are comprised of reconfigurable processing units to meet the computational need of an application. FIG. 2 shows the functional block of each hierarchical plane where the PLPP 230 has an array of input pixels, extracts early visual features, and feedforwards to the SLPP plane 250. This plane executes comparatively higher-level processing and propagates information to the NIP 280 for complex processing.

Pixel-Level Processing Plane (PLPP)

As shown in FIG. 2, PLPP 230 is the initial or first stage in the hierarchy that is responsible for image acquisition and low-level processing. This plain has two components, one or more Pixel Processing Units (PPU) 231-235 along with other PPUs and a plurality of Clock Musks (CMs) 237 and 238. The PPUs in this plane may be arranged in several groups such as a first group comprising a plurality of PPUs such as PPUs 231 and 232 along with other PPUs with separately assigned CM 237 and a second group comprising a plurality of PPUs such as PPUs 233-235 along with other PPUs with separately assigned CM 238.

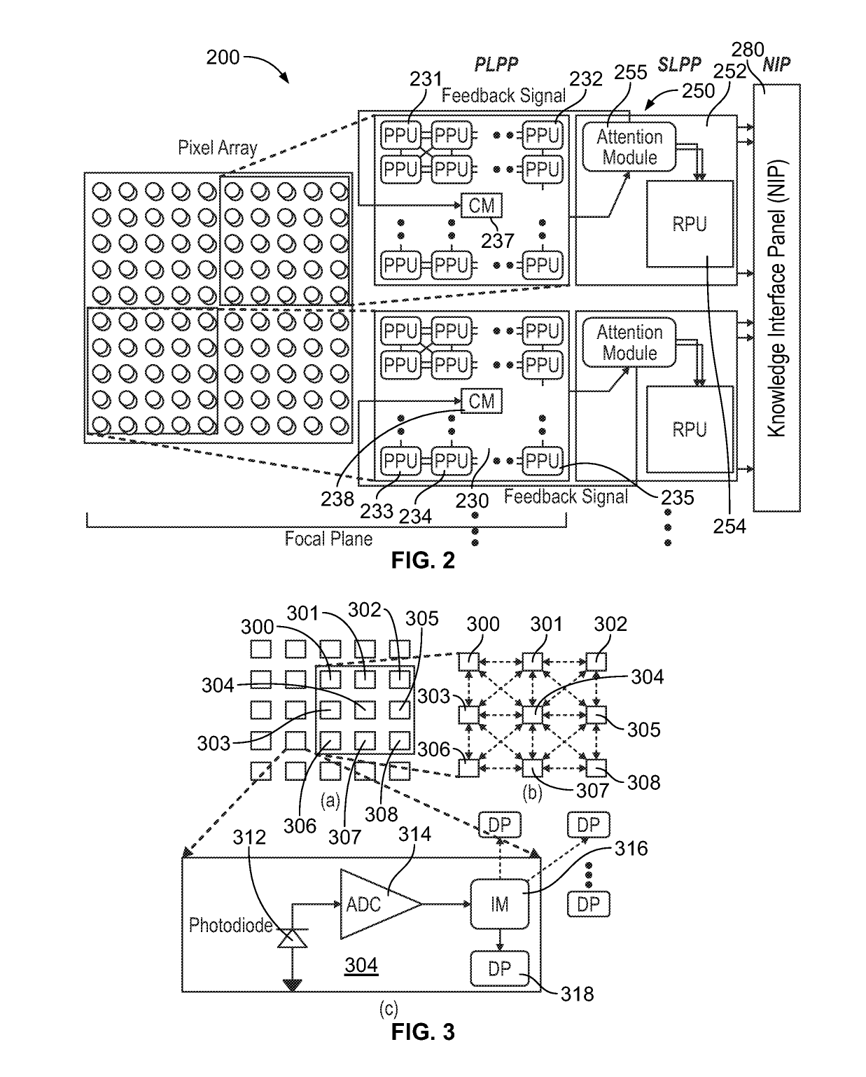

As shown in FIG. 3A, the PPUs may be formed into one or more arrays comprised of a plurality of PPUs such as PPUs 300-308. As shown in FIG. 3B, the PPUs are interconnected with each of its neighbors. For example, as shown, PPU 304 is interconnected with PPUs 300-303 and 305-308. As shown in FIG. 3C, each PPU such as PPU 304, may contain a photodiode (PD) 312, an analog-to-digital converter (ADC) 314, Interconnect Manager (IM) 316, and a Digital Processor (DP) 318.

The PD detects the photon energy imposed on it and creates a photocurrent. The analog photo-current is converted to an 8-bit digital signal by the ADC. Hence, the imposed scene on the focal plane where the PPUs are located is transformed into a gray-scale image.

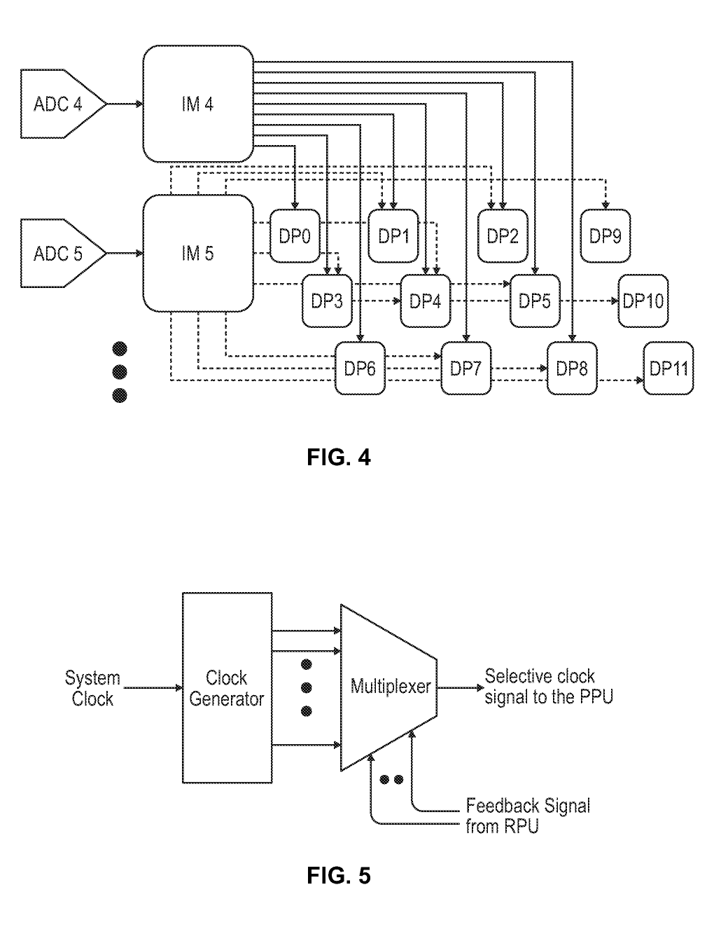

The ADC is followed by an IM as shown in FIG. 4 which may instantly transfers data to its DP and to the neighboring DPs. As shown, IM4 transfers the data to DP0 to DP8 and IM5, in the same way, transfers data to its neighbors. Instead of storing the data, the IM may update pixel values in each clock cycle.

The architecture of the PPU gives the option to perform independent operations in each PPU in parallel which gives a pixel-parallel architecture with high throughput. Each DP has its own pixel value along with its neighboring values and with those values, the DP can extract the early visual features and determine whether it lies on a salient point. The reconfigurable DP can perform filtering, edge/corner detection, thresholding, or different morphological operations like dilation and erosion in the input plane depending on the application need.

A group of PPUs corresponds to a computational unit (XPU) in the second plane, which gives feedback signals to the corresponding CM. For example, as shown in FIG. 2, XPU 252 gives feedback signals to the corresponding CM 237. This feedback signal serves as a selector on the CM to assign appropriate clock frequencies to different groups of PPUs as shown in FIG. 5. The clock assignment allows the model to perform computation at different speeds in the PLPP while maintaining consistency. The purpose of the clock musk is to slow down operations in the irrelevant regions of an image to reduce power consumption. The focal plane computation in the PLPP layer provides high throughput by performing pixel sensing and low-level processing in parallel over all PPUs. In a 3D-chip implementation, the PPUs will propagate the relevant information by a feedforward signal to the next stage for high-level processing.

Structure-Level Processing Plane (SLPP)

As shown in FIG. 2, SLPP 250 is the second or next level stage in the hierarchical model. The plane takes inputs from the PLPP, generates outputs with a more complicated image processing algorithm, and forwards them to the next stage. In addition, the SLPP shares the relevance information with the PLPP through feedback signals. The XPUs in this plane have Regional Processing Units (RPUs) and attention modules. For example, XPU 252 has two components, Regional Processing Unit (RPU) 254 and the attention module 255.

A Regional Processing Unit (RPU) has a more coarse-grained processor and operates on broader regions of the image than the PPU. Where the PPU is responsible for only one pixel and calculates the visual features, the RPU processes on a group of pixels. In FIG. 2, each group in the PLPP, corresponds to an RPU. The reconfigurable RPUs execute higher level functions (e.g. line/circle, shape detection) on the incoming data. Each RPU in this layer performs the same operation and gives a distributed output which is forwarded to the third plane through a bus. For example, if the SLPP is performing line detection, each RPU will execute a similar detection algorithm on their corresponding pixel data and the distributed line detected image will be streamed to NIP 280 by a bus.

An Attention Module is part of the SLPP layer which operates on the extracted early features from the PLPP and generates feedback and a feedforward signal to drive the PPU and RPU respectively. The module is responsible for computing the visual saliency in a region by applying simple algorithms. When the ROI is detected in the attention module, it generates a saliency score for the region which is sent as a feedback signal to the CM. If the saliency score, which may be based on a predetermined grayscale threshold, is insignificant or not met, the feedforward signal postpones the computation in the RPU and the feedback signal instructs the CM to assign a slow-clock to that region which decreases the sampling rate of an array. Low saliency scores also represent insignificant regions in an image and those regions remain unresponsive by human eyes and the attention module emulates this concept. Alternately, when saliency score becomes significant, RPU starts its processing and PPU executes visual features using a fast-clock.

Knowledge Interface Plane (NIP)

The output of the SLPP is combined to infer knowledge of the scene in the NIP. Sequences of discrete features such as lines, circles, rectangles, and, contours can be combined to infer knowledge of a scene which may include a representation of the image or a feature of the image. As opposed to the PLPP and SLPP, which operate on large amounts of data, the features are vastly reduced in the NIP to the extent that they can be processed sequentially by an embedded processor with average performance. The integration of a relevance feedback method in the present invention further limits features to only relevant regions of an image. The knowledge inference plane implements machine learning, or some other processing preferred by the user to accumulate all the segregated information obtained from the RPUs which may be used in certain embodiments to form a larger representation of the image. The NIP receives inputs from each RPU in parallel. In addition, the RPUs having no relevant information may be discarded by the NIP. Hence, the effective inputs for the sequential processor are minimized and this feature enhances the system performance by speeding up the operation. The designed system-on-chip architecture, with a low-frequency processor, enhances the speed-up and performance by reducing the effective inputs.

The key feature of the hierarchical architecture using XPUs is the maximal parallelism provided vertically and horizontally within and across processing planes. In addition, the three layers described above for the various embodiments of the present invention maintain a hierarchy and each layer communicates with its adjacent layers in real-time. The layered structure introduces a 3D pixel-parallel structure. Coming down from the PLPP to the NIP, there may be a gradual degradation in data volume and increasing the complexity of image processing; which is a common feature of a bottom-up architecture in the brain. In the nervous system, as we go deeper from the retina to the deep layer, the complexity of processing increases. The visual attention scheme in the nervous system decreases the data volume from layer to layer. In the human visual system, from Retina to Layer-4 early visual features are extracted, complex processing is carried through Layer-5 to deep layer, and the deep-layer accumulates all information and gives the final output. Transitioning from the human visual system to a design of the present invention, the PLPP emulates retina to Layer-4, the SLPP imitates Layer-5 up to deep-layer and, the NIP acts like the deep layer. This emulates the concept of the human visual system in a circuit by designing a pixel-parallel focal plane smart neuromorphic image sensor with a bottom-up hierarchical 3D architecture.

To rationalize the architecture for an embodiment, real-time lane detection application was adopted. In the first layer, reconfigurable digital processors were assigned to execute edge detection. The reconfigurable DP also offers other operations for example corner detection, image smoothing, and image thresholding. The edge detected image is feedforward to the SLPP plane and the attention module receives data and computes the saliency score for the region. If the score is one, then the reconfigurable RPU finds the possible lines in the block. At the same time, it tells PPU for fast operation since this pixel lies in a visually salient region and the RPU sends the discrete line detected image to the NIP. Alternately, if the score is zero, PPUs are assigned to a 10× slower clock from the next clock cycle and the RPU stops execution. The NIP executes a clustering algorithm on its reduced number of inputs which finds the possible lanes in the whole image from the distributed lines. The proposed architecture can be applied to a large set of image processing applications where real-time operation is needed.

In a specific use, a Virtex-7 FPGA board from Xilinx was used as an evaluation platform. RTL analysis provides latency, resource utilization, and power consumption of each hierarchical plane. The basic components were tested in an Application-specific integrated circuit (ASIC) domain. A Design-Compiler from Synopsys and Innovus from Cadence were used to achieve the layout design of each unit in 90 nm technology. The results show that by trading off resource overhead, high throughput is obtained while reducing redundancy and power consumption. The proposed architecture can be applied to a large set of image processing applications where real-time operation is needed.

By increasing the clock period by 10 times, 89.23% of power consumption from the DP may be saved. In the pixel-parallel architecture, the whole edge detected image will be available after 0.72 ns based on the ASIC implementation. It is mentioned earlier that the PPU has a PD, ADC, DP, and IM for the focal plane operation. Here, the area of the PPU is estimated by considering the active areas of those units. The simulated result shows that DP and IM occupy less area compared to the ADC and PD (ADC consumes 0.36 mm² and the PD takes an area of 0.52×0.52 mm²). In one design, the DP is kept small by intention to achieve a better fill factor. Based on the information provided, the fill factor can be improved up to 42.9% in the PPU. For the resource utilization analysis, PLPP uses 81% LUT and 0.4% FFs resources, SLPP also uses 69% LUT and 3.7% FFs resources.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiments, methods, and examples, but by all embodiments and methods within the scope and spirit of the disclosure.

What is claimed is:

1. A digital image capturing and processing system comprising:
a plurality of intertwined processing planes comprised of at least one initial processing plane, at least one intermediate processing plane and at least one final processing plane;
said at least one initial processing plane having a plurality of arrays, each array comprised of a plurality of pixel processors which are interconnected and each of said pixel processors converts a single pixel of the image into a gray-scale output of a pixel;
said at least one intermediate processing plane having a plurality of regional processors each of which receives said gray-scale outputs processed by an array, each of said regional processors process said gray-scale output to detect a discrete feature of the image formed from a plurality of pixels and the detected discrete feature is outputted by each regional processor to said at least one final processing plane; and
said at least one final processing plane processes said detected discrete features to form a larger representation of the image.

2. The system method of claim 1 wherein said discrete features are lines, circles, rectangles, and contours of the image.

3. The system method of claim 1 wherein said discrete features are combined by said at least one final processing plane.

4. The system of claim 1 further including a feedback loop between said at least one initial layer and said at least one intermediate layer wherein the sampling rate of an array is decreased when a predetermined grey-scale threshold is not met.

5. The system of claim 1 wherein said pixel processers are connected to a clock musk having a clock cycle and each of said pixel processers comprised of at least one photon detector, at least one analog to digital converter, at least one interconnect manager and at least one digital processor.

6. The method of claim 1 wherein each of said regional processors perform the same operation to create a distributed output which is forwarded to said at least one final processing plane.

7. The system of claim 1 wherein said interconnect manager transfers output received from said ADC to its DP and to the other DPs in said array.

8. The system of claim 1 wherein said at least one interconnect manager updates pixel values in each clock cycle.

9. A method of digital image capturing and processing comprising the steps of:
providing a plurality of intertwined processing planes comprised of at least one initial processing plane, at least one intermediate processing plane and at least one final processing plane;
said at least one initial processing plane having a plurality of arrays, each array comprised of a plurality of pixel processors which are interconnected and each of said pixel processors converts a single pixel of the image into a gray-scale into a gray-scale output of a pixel;
said at least one intermediate processing plane having a plurality of regional processors each of which receives said gray-scale images processed by an array, each of said regional processors process said gray-scale images to detect a discrete feature of the image and the detected discrete feature is outputted by each regional processor to said at least one final processing plane; and
said at least one final processing plane processes said detected discrete features to form a larger representation of the image.

10. The method of claim 9 wherein said discrete features are lines, circles, rectangles, and contours of the image.

11. The method of claim 9 wherein said discrete features are combined by said at least one final processing plane.

12. The method of claim 9 further including a feedback loop between said at least one initial layer and said at least one intermediate layer wherein the sampling rate of an array is decreased when a predetermined grey-scale threshold is not met.

13. The method of claim 9 wherein said pixel processers are connected to a clock musk having a clock cycle and each of said pixel processers comprised of at least one photon detector, at least one analog to digital converter, at least one interconnect manager and at least one digital processor.

14. The method of claim 9 wherein each of said regional processors perform the same operation to create a distributed output which is forwarded to said at least one final processing plane.

15. The method of claim 9 wherein said interconnect manager transfers output received from said ADC to its DP and to the other DPs in said array at a time.

16. The method of claim 9 wherein said at least one interconnect manager updates pixel values in each clock cycle.

17. The method of claim 9 wherein each PPU plane communicates with its adjacent plane in real-time.

18. The system of claim 1 wherein each plane communicates with its adjacent plane in real-time.

19. The method of claim 9 wherein said at least one final processing plane receives inputs from each regional processor in parallel.

20. The system of claim 1 wherein said at least one final processing plane receives inputs from each regional processor in parallel.
